(19) United States
(12) Patent Application Publication
(10) Pub. No.: US 2010/0023687 A1
(43) Pub. Date: Jan. 28, 2010

(54) METHOD FOR PROVIDING A CUSTOMIZED RESPONSE FROM A DISK ARRAY

(75) Inventors: Chih-Wei CHEN, Taipei City (TW); Hsiao-Fen Lu, Taipei City (TW)

Correspondence Address: BRIAN M. MCINNIS, 12th Floor, Ruttonjee House, 11 Duddell Street, Hong Kong, HK

(73) Assignee: INVENTEC CORPORATION

(21) Appl. No.: 12/252,664

(22) Filed: Oct. 16, 2008

(30) Foreign Application Priority Data
Jul. 22, 2008 (TW) 97127846

(51) Int. Cl. G06F 12/00

(52) U.S. Cl. 711/114; 711/E12.001

(57) ABSTRACT

The present invention discloses a method for providing a customized response from disk array, which is implemented on a disk array server having disks. The method comprises steps of receiving a request packet from a front end server, determining whether the request packet is for a response of disk environment information of one of the disks, and directly providing a customized response back to the front end server when the request packet is for a response of disk environment information of one of the disks, or passing the request packet to an originally aimed disk of the disk array server when the request packet is for data access on the originally aimed disk.

### RELATED APPLICATIONS

This application claims priority to Taiwan Application Serial Number 97127846, filed Jul. 22, 2008, which is herein incorporated by reference.

### BACKGROUND

1. Field of Invention

The present invention relates to a method for providing a customized response. More particularly, the present invention relates to a method for providing a customized response from a disk array.

2. Description of Related Art

In the traditional implementation of a network access server (NAS), a disk array system connected to the NAS via networks provides the NAS with available storage space for enabling the NAS to process data access and system information inquiries to the disk array system. When a front-end client processes system information inquiries from the NAS to the disk array system for remaining storage space information thereof, the NAS requests a status report to the disk array system therefor. Then, the disk array system accurately responds the remaining storage space information thereof in reality for front-end clients.

However the available storage space in the disk array system may have been reserved for customized utilization such as I/O optimization of storage space. Therefore when a front-end client requests a status report for the available storage space, the system might not provide accurate information about the available storage space thereof to the front-end client. That is the available storage space reported to the front-end client may exclude the storage space reserved for the customized utilizations even if this storage space is not being used.

A maker of the disk array system currently equips more than one kind of network connecting interfaces and disk connecting interfaces on a single one disk array system, the disk array system can be compatible with one of commonly-used network interfaces and disk connecting interfaces.

In consequence of the disk array system equipped with the different kinds network interfaces and disk connecting interfaces, the maker further needs to install different hardware drivers in which each hardware driver corresponds to one network connecting interface or disk connecting interface and is capable of activating it up.

Whenever an administrator of the disk array system attempts to reach the I/O optimization or process some customized utilizations of the storage space for the disk array system, the administrator must repeatedly and separately modify the driver codes of each hardware driver corresponding to the disk connecting interface or the network connecting interface such that to ensure the disk array system outputs a predetermined response from any disk connecting interface or any network connecting interface.

In additional, when the hardware drivers are updated with the latest revisions, the administrator has to repeatedly and separately modify the driver code of each updated hardware driver to output the predetermined response. Therefore, different front-end clients will obtain different predetermined responses via the connected NAS.

Hardware drivers are generally updated fairly frequently. This means the programs of the hardware drivers also have to be modified by the administrator on a regular basis. This process is time consuming and wastes a lot of the administrator's time and is therefore also very costly.

### SUMMARY

It is therefore an aspect of the present invention to provide a method for providing a customized response from a disk array, which saves time in repeatedly and separately modifying each hardware driver program, and maintains the I/O optimization efficiency to further lessen the maintenance cost.

It is therefore another aspect of the present invention to provide a response of predetermined system information which an administrator of the disk array has decided previously, instead of a response of the real system information when the front-end clients inquire for the system information of the disk array.

Another aspect of this present invention is to accelerate the development of upgraded products and reduce the human errors incurred when administrators frequently modify the programs themselves.

The present invention discloses a method for providing a customized response from disk array, which is implemented on a disk array server having disks. The method comprises steps of receiving a request packet from a front end server, determining whether the request packet is for a response of system information of the disk array, and directly replying a customized response to the front end server when the request packet is only asking for a response of system information of the disk array, or passing the request packet to an originally aimed disk of the disk array server when the request packet is only for data access to the originally aimed disk.

According to a preferred embodiment of the present invention, the disk array server further has an agent program and plural types of network interfaces. Each network interface type respectively corresponds to one network interface driver program, and each of the network interface driver programs activates the corresponding network interface to receive the request packet from the front end server.

Each disk has a disk interface corresponding to one disk interface driver program, and the disk interface driver program activates the corresponding disk interface to receive the request packet when the request packet is asking for data access.

When the request packet is starting to be transmitted from one of the network interface driver programs to one of the disk interface driver programs, the network interface driver program sends the request packet to the agent program first. Because the agent program has same interfaces and parameters as the disk interface driver programs and the network interface driver programs do, the agent program is allowed to receive and determine the request packet's purpose and the agent program will only pass the request packet to an originally aimed disk of the disk array server when the request packet is only for data access to the originally aimed disk.

Furthermore, the agent program analyzes the purpose of the request packet and determines whether the request packet is asking for one disk's available disk space of the disk array. When the agent program determines that the request packet is asking for one disk's available disk space, the agent program sends a predetermined first customized response to the front end server according to a first predetermined reference, wherein the first predetermined reference is only a part of the actual available disk space thereof, not the whole available disk space thereof.

Or, when the request packet is asking for the vendor information of the disk array server, the agent program sends a second predetermined customized response to the front end server according to a second predetermined reference, wherein the second predetermined reference is vendor information of a customized disk array server and not the information of the disk array server's manufacturer or retailer.

It is to be understood that both the foregoing general description and the following detailed description are examples, and are intended to provide further explanation of the invention as claimed.

### BRIEF DESCRIPTION OF THE DRAWINGS

These and other features, aspects and advantages of the present invention will become better understood with regard to the following description, appended claims and accompanying drawings where:

FIG. 1 is a block diagram of a disk array server and a front end server according to the present invention;

FIG. 2 is an operation flow chart according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

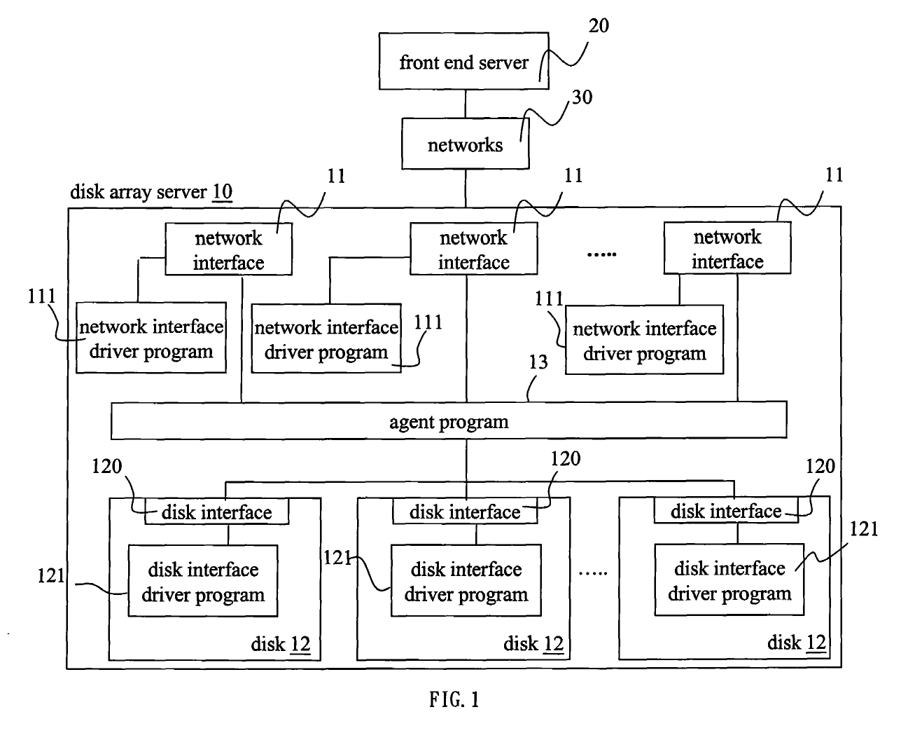

Refer to FIG. 1. FIG. 1 is a block diagram of a disk array server and a front end server 20 according to the present invention. The present invention discloses a method for providing a customized response from a disk array. The method is implemented on a disk array server 10. The disk array server 10 has at least one network interface 11 and one disk 12. The disk array server 10 receives a request packet (e.g. I/O Request Packet) through the network interface 11. When the disk array server 10 determines the request packet is asking for a response of system information of the disk array server 10, the disk array server 10 immediately replies a predetermined customized response not as same as the real system information that the request packet asks for. Thus, an administrator of the disk array server 10 can decide to provide of real or false system information and prevent the real system information from being obtained externally.

Refer to FIG. 1 again. In order to provide highly compatible customized products for clients, the disk array server 10 in a preferred embodiment of the present invention is usually furnished with a number types of network interfaces 11 including Fibre Channel, iSCSI and Infini Band etc. Each network interface 11 cooperates with a kind of network interface driver program 111, and is activated by the corresponding network interface driver program 111 thus, the network interface 11 electrically connects to a front end server 20 (e.g. web server) through the networks 30.

Furthermore, the disk array server 10 disposes a number of disks 12 (e.g. SCSI, SATA, SAS, IDE, and Fibre Hard Disk etc.). Since those disks 12 in the disk array server 10 are provided by different disk manufacturers, those disks 12 may be furnished with different type of disk interfaces 120 such as SCSI and ATAPI. Each type of disk interface 120 has a disk interface driver program 121, and is activated by the corresponding disk interface driver program 121 to electrically connect the corresponding disk 12 and the connected network interface 11, which connects with the front end server 20.

An agent program 13 is an important feature of the invention. The agent program 13 is installed in the disk array server 10. When the request packet is transmitted from one of the network interface driver programs 111 to one of the disk interface driver programs 121, the network interface driver program 111 sends the request packet to the agent program 13 first, thus, the agent program transmits the request packet between the disk interface driver programs and the network interface driver programs. Because the agent program 13 has same interfaces and parameters as the disk interface driver programs 121 and the network interface driver programs 111 do, the agent program 13 is allowed to receive and determine the request packet's purpose.

Thus, the agent program 13 will only pass the request packet to an originally aimed disk 12 of the disk array server 10 when the request packet is only for data access to the originally aimed disk 12.

Otherwise, when the request packet passed to the agent program 13 are determined that the request packet is asking for system information, the agent program 13 responds a predetermined customized response to the front end server 20 on behalf of the disk interface driver program 121 or the network interface driver program 111 immediately.

Since the agent program 13 can independently respond to a predetermined customized response for the request packet without modifying each of the disk interface driver programs 121 and the network interface driver programs 111, the invention saves time in repeatedly and separately modifying the disk interface driver programs 121 and the network interface driver programs 111 in advance.

Additionally, the agent program 13 can also be installed in an operating system of the disk array server 10 and the administrator of the disk array server 10 is allowed to modify the disk interface driver programs 121 and the network interface driver programs 111 instantly according to any change in the predetermined customized response.

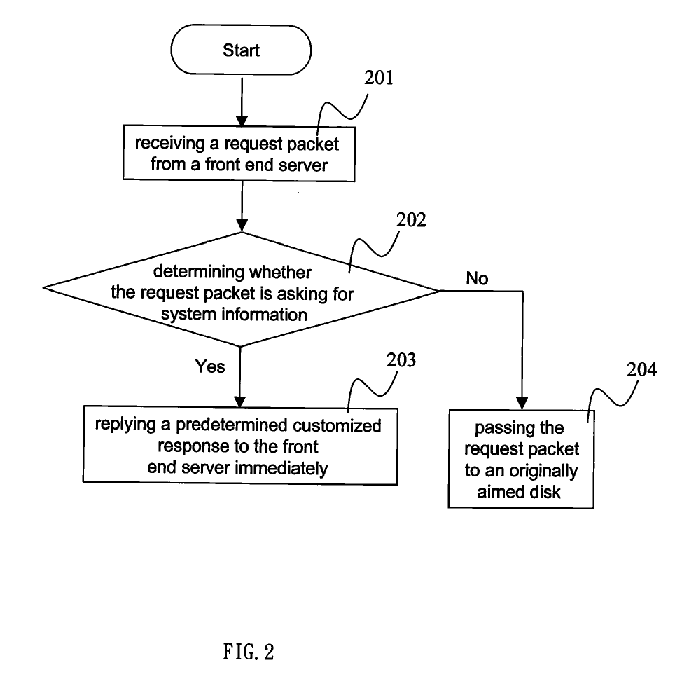

The agent program 13 immediately replies the predetermined customized response about the disk environment information of the disk 12 for the request packet only if the request packet asks for disk environment information of the disk 12, but the agent program 13 passes another request packet to an originally aimed disk 12 if the another request packet is asking for data access to the originally aimed disk 12. Refer to FIG. 2. FIG. 2 is an operation flow chart according to one preferred embodiment of the present invention and describes as following:

In step (201): a request packet sent from the front end server 20 is received. When the connected network interface 11 receives a request packet from the front end server 20, the network interface driver program 111 directly sends the request packet towards the agent program 13 to analyze the purpose of the request packet (e.g. for data access or for information inquiry);

In step (202): determines whether the received request packet is asking for system information. In this step, the agent program 13 analyzes a service type of the received request packet and determines whether the received request packet is for a response of disk environment information of any disk 12, if yes, go to step (203), otherwise go to step (204);

In step (203): replying a predetermined customized response to the front end server 20 immediately according to a predetermined reference. Since the request packet asks for system information is mostly for a response about disk environment information such as vendor's information and available disk space etc., the two embodiments are precisely described the practice of the agent program 13 in the invention. However, these embodiments are not limited in the invention at all, any I/O optimization for the disk space may be achieved by the agent program 13.

Embodiment (i): when the request packet is asking for a response of the available disk space of an available disk for the front end server 20, the agent program 13 creates a first customized response and sends it back to the front end server 20 according to a first predetermined reference set previously by the administrator of the disk array server 10. Here, the first predetermined reference is not the actual available disk space thereof, and can only be a part of the actual available disk space thereof as the administrator sets. Therefore, it helps the administrator to easily arrange the available disk space of all disks 12 to other front end server 20 or for other uses.

Embodiment (ii): when the request packet is for a response of the vendor information of the disk array server 10, the agent program 13 provides a second predetermined customized response and sends it back to the front end server 20 according to a second predetermined reference set previously by the administrator of the disk array server 10. Here, the second predetermined reference is the vendor's information (e.g. vendor function type code) of a customized disk array server 10 as the administrator plans instead of the information of the manufacturer or retailer of the disk array server 10. Therefore, it ensures that the vendor's information of the customized disk array server 10 can be obtained outwardly.

In step (204): passing the request packet to an originally aimed disk 12 to process data access regularly. When the agent program 13 determines that the received request packet is for data access according to the service type of the received request packet, the agent program 13 passes the received request packet to an originally aimed disk 12 according to the destination address of the received request packet. Thus, the received request packet processes data access to the originally aimed disk 12.

To sum up, the present invention using the agent program 13 to directly respond a customized response for information inquiry on behalf of all network interface driver programs 111 and the disk interface driver programs 121 may save time that the administrator of the disk array server 10 repeatedly and separately modifies codes in the network interface driver programs 111 and the disk interface driver programs 121.

Also, since the agent program 13 will respond to any information inquiry for these network interface driver programs 111 and the disk interface driver programs 121, no matter how these network interface driver programs 111 and the disk interface driver programs 121 are adjusted for I/O optimization, these network interface driver programs 111 and the disk interface driver programs 121 will not need to be adjusted for the customized responses again.

Furthermore, the customized response provided by the agent program 13 will not affect any parameters or the environment by modifying the network interface driver program 111 and the disk interface driver program 121. The agent program 13 also can be implemented on other related system to accelerate the development of upgraded products and reduce the human errors incurred when administrators frequently modify those programs themselves.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for providing a customized response from disk array, which implemented on a disk array server having a plurality of disks, the method comprising:
receiving a request packet from a front end server;
determining whether the request packet is for a response of system information of the disk array server; and
directly replying a predetermined customized response to the front end server when the request packet is for a response of the system information of the disk array server;
directly passing the request packet to an originally aimed disk of the disk array server when the request packet is only for regular data access to the originally aimed disk.

2. The method of claim 1, wherein the disk array server has different types of network interfaces respectively corresponding to one network interface driver program, and each of the network interface driver programs activates the corresponding network interface to receive the request packet from the front end server.

3. The method of claim 2, wherein each of the disks has a disk interface corresponding to one disk interface driver program, and the disk interface driver program activates the corresponding disk interface to receive the request packet when the request packet is asking for data access.

4. The method of claim 3, wherein the disk array server has an agent program, wherein when the agent program receives a request packet from the network interface, the agent program analyses and determines whether the request packet is asking for a response of system information of the disk array server;
providing the customized response according to a predetermined reference in the disk array server when the request packet is asking for the system information of the disk array server; and
sending the customized response back to the front end server immediately.

5. The method of claim 4, wherein when the request packet is asking for a response of the available disk space of one of the disks for the front end server, the agent program sends a first predetermined customized response to the front end server according to a first predetermined reference, wherein the first predetermined reference is only a part of the actual available disk space thereof.

6. The method of claim 4, wherein when the request packet is asking for vendor information of the disk array server, the agent program sends a second predetermined customized response to the front end server according to a second predetermined reference, wherein the second predetermined reference is vendor's information of a customized disk array server.

7. The method of claim 4, wherein the agent program transmits the request packet between the disk interface driver programs and the network interface driver programs, and has the same interfaces and parameters of the disk interface driver programs and the network interface driver programs do.

8. The method of claim 4, wherein the agent program is installed in an operation system of the disk array server.
